(19) United States
(12) Patent Application Publication
(10) Pub. No.: US 2022/0132569 A1
(43) Pub. Date: Apr. 28, 2022

(54) Methods For URLLC FBE UE-Initiated COT Enhancement In Mobile Communications

(71) Applicant: MediaTek Singapore Pte. Ltd., Singapore (SG)

(72) Inventors: Abdellatif Salah, Cambridge (GB); Mohammed S Aleabe Al-Imari, Cambridge (GB); Pradeep Jose, Cambridge (GB); Cheng-Rung Tsai, Hsinchu City (TW); Chiou-Wei Tsai, Hsinchu City (TW)

(21) Appl. No.: 17/501,180

(22) Filed: Oct. 14, 2021

Related U.S. Application Data
(60) Provisional application No. 63/094,918, filed on Oct. 22, 2020.

(51) Int. Cl. H04W 74/08; H04W 72/14; H04W 72/12

(52) U.S. Cl. CPC H04W 74/0808; H04W 74/0833; H04W 72/1289; H04W 72/1284; H04W 72/14

(57) ABSTRACT

Various solutions for Ultra-Reliable Low-Latency Communication (URLLC) Frame Based Equipment (FBE) user equipment (UE)-initiated channel occupancy time (COT) enhancement in mobile communications are described. An apparatus, implementable in a UE, receives a signal from a network and obtains a UE-initiated COT in an idle or connected mode responsive to receiving the signal. The apparatus then performs a transmission to the network in the UE-initiated COT.

### CROSS REFERENCE TO RELATED PATENT APPLICATION(S)

The present disclosure is part of a non-provisional application claiming the priority benefit of U.S. patent application Ser. No. 63/094,918, filed 22 Oct. 2020, the content of which being incorporated by reference in its entirety.

### TECHNICAL FIELD

The present disclosure is generally related to mobile communications and, more particularly, to techniques for Ultra-Reliable Low-Latency Communication (URLLC) Frame Based Equipment (FBE) user equipment (UE)-initiated channel occupancy time (COT) enhancement in mobile communications.

### BACKGROUND

Unless otherwise indicated herein, approaches described in this section are not prior art to the claims listed below and are not admitted as prior art by inclusion in this section.

In wireless communications, such as mobile communications under the 3^{rd} Generation Partnership Project (3GPP) specification(s) for 5^{th} Generation (5G) New Radio (NR), two types of listen-before-talk (LBT) channel access are employed, namely Load Based Equipment (LBE) and Frame Based Equipment (FBE). In FBE-based LBT, a UE is allowed to perform clean channel assessment (CCA) to sense if a channel is idle, and this is done for every fixed frame period (FFP). If and when the UE accesses the channel, the UE would occupy the channel for a fixed period of time known as a COT, and then the UE would wait for a period equal to 5% of the COT for a next transmission. This period is referred to as an idle period herein.

In Releases 16 (Rel-16) of the 3GPP specification for (s) for NR unlicensed band (NR-U), a FBE mode of operation by a UE has been defined. Unlike a LBE mode, the frame period in the FBE mode is fixed by configuration, and the FFP is limited to a set of predefined times of {1 ms, 2 ms, 2.5 ms, 4 ms, 5 ms, 10 ms}. The starting positions of the FFPs within every two radio frames starts from an even radio frame, with a minimum idle period being allowed which can be expressed as: minimum idle period allowed=max(5% of FFP, 100 μs).

Under the Rel-16 NR-U, only a base station (e.g., gNB) can act as an initiating device while the UE can only act as a responding device. To initiate a COT, the gNB would perform a one-shot listen-before-talk (LBT) with 9 μs slot measured within a 25 μs interval as defined in the 3GPP Technical Specification (TS) 37.213. Within a gNB-initiated COT, the gNB or UE can resume transmission with an arbitrary gap with another one-shot LBT. If the transmission gap is within 16 μs, no LBT is needed. The FBE mode initiator and FFP configuration are included in remaining minimum system information (RMSI) (e.g., system information block 1 (SIB1)) and FFP can also be signaled for a UE with UE-specific radio resource control (RRC) signaling. UE transmissions within a fixed frame period can occur if downlink (DL) signals/channels (e.g., physical downlink control channel (PDCCH), synchronization signal block (SSB), physical broadcast channel (PBCH), RMSI, group common PDCCH (GC-PDCCH), and so on) within the fixed frame period are detected. A physical random access channel (PRACH) resource is considered invalid if it overlaps with the idle period when FBE operation is indicated.

In semi-static channel access mode (e.g., FBE) as defined in Rel-16, as only a gNB-initiated COT is supported, there are scheduling and configuration restrictions on uplink (UL) transmissions, and only DL transmissions are allowed at the beginning of an FFP. This, however, can negatively impact the latency requirements for URLLC and Industrial Internet-of-Things (IIoT) operations. Moreover, for a UE to transmit in UL, the UE need to determine whether the gNB has initiated a COT in the FFP. This means the UE needs to monitor the channel to detect any DL transmission in the FFP, and this would increase power consumption at the UE. In case of a dynamic grant (DG), COT initiation within a FFP can be indicated to the UE by explicit signaling. In case of a configured grant (CG), the UE implicitly determines whether a COT in the FFP is initiated by monitoring the channel to detect any DL transmission in the FFP, and the gNB should transmit a DL signal (if there is nothing to schedule) to allow UEs to transmit in CG. Therefore, there is a need for a solution to FBE UE-initiated COT enhancement for URLLC and IIoT in NR-U in mobile communications.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to propose solutions or schemes that address the issue(s) described herein. More specifically, various schemes proposed in the present disclosure are believed to provide solutions for FBE UE-initiated COT enhancement for URLLC and IIoT in NR-U in mobile communications. For instance, under various schemes proposed herein, a UE-initiated COT may be enabled for the purpose of supporting URLLC in controlled unlicensed-band environments operating based on FBE structure. It is believed that the latency budget and power consumption may be considerably improved by allowing UE-initiated COT in a semi-static channel access mode.

In one aspect, a method may involve a UE receiving a signal from a network. The method may also involve the UE obtaining a UE-initiated COT in an idle or connected mode responsive to receiving the signal. The method may further involve the UE performing a transmission to the network in the UE-initiated COT.

In another aspect, a method may involve a UE receiving, from a network, a signal which may be an RRC signal or a dynamic signal used by the network to enable or disable a COT-initiation functionality of the UE. The method may also involve the UE obtaining a UE-initiated COT responsive to receiving the signal. The method may further involve the UE performing a transmission to the network in the UE-initiated COT.

In yet another aspect, a method may involve a UE receiving, from a network node of a network, a downlink control information (DCI) with an indication informing the UE whether or not to initiate a COT in a FFP associated with the UE or the network node in a future FFP. The method may also involve the UE obtaining a UE-initiated COT in an idle or connected mode responsive to receiving the signal. The method may further involve the UE performing a transmission to the network in the UE-initiated COT.

It is noteworthy that, although description provided herein may be in the context of certain radio access technologies, networks and network topologies such as 5G/NR mobile communications, the proposed concepts, schemes and any variation(s)/derivative(s) thereof may be implemented in, for and by other types of radio access technologies, networks and network topologies such as, for example and without limitation, Long-Term Evolution (LTE), LTE-Advanced, LTE-Advanced Pro, Internet-of-Things (IoT), Narrow Band Internet of Things (NB-IoT), Industrial Internet of Things (IIoT), vehicle-to-everything (V2X), and non-terrestrial network (NTN) communications. Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation in order to clearly illustrate the concept of the present disclosure.

FIG. 1 is a diagram of an example network environment in which various proposed schemes in accordance with the present disclosure may be implemented.

FIG. 2 is a diagram of an example scenario under various proposed schemes in accordance with the present disclosure.

FIG. 3 is a block diagram of an example communication system in accordance with an implementation of the present disclosure.

FIG. 4 is a flowchart of an example process in accordance with an implementation of the present disclosure.

FIG. 5 is a flowchart of an example process in accordance with an implementation of the present disclosure.

FIG. 6 is a flowchart of an example process in accordance with an implementation of the present disclosure.

### DETAILED DESCRIPTION OF PREFERRED IMPLEMENTATIONS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to FBE UE-initiated COT enhancement for URLLC and IIoT in NR-U in mobile communications. According to the present disclosure, a number of possible solutions may be implemented separately or jointly. That is, although these possible solutions may be described below separately, two or more of these possible solutions may be implemented in one combination or another.

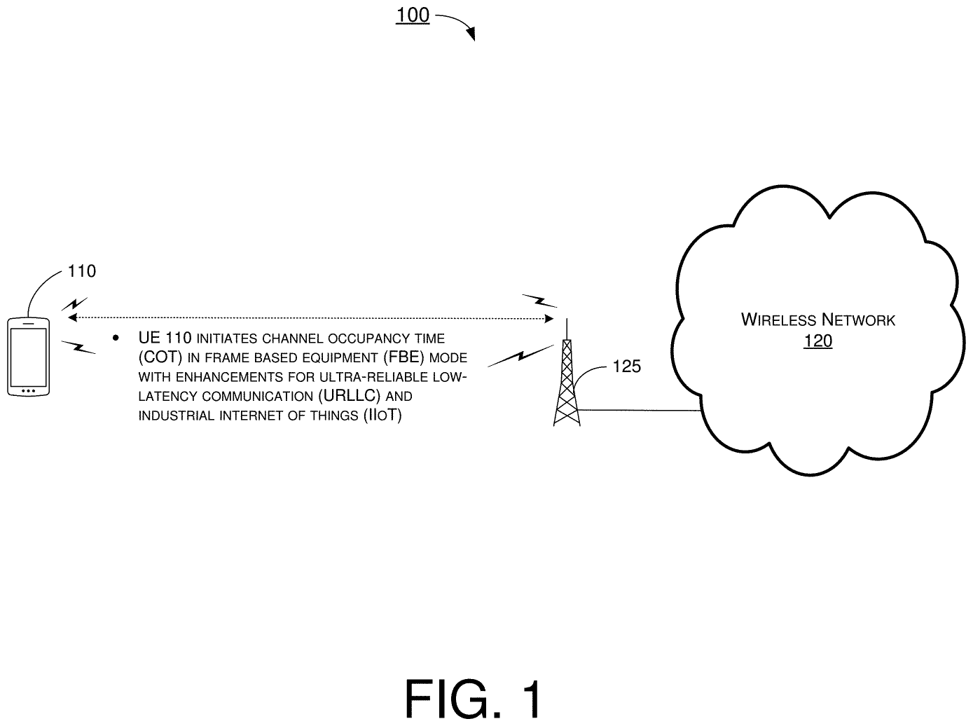

FIG. 1 illustrates an example network environment 100 in which various solutions and schemes in accordance with the present disclosure may be implemented. Referring to FIG. 1, network environment 100 may involve a user equipment (UE) 110 in wireless communication with a wireless network 120 (e.g., a 5G NR mobile network and/or another type of network such as a LTE network, a LTE-Advance network, a NB-IoT network, an IoT network, an IIoT network and/or an NTN). UE 110 may be in wireless communication with wireless network 120 via a base station or network node 125 (e.g., an eNB, gNB or transmit-receive point (TRP)). In network environment 100, UE 110 and wireless network 120 may implement various schemes pertaining to FBE UE-initiated COT enhancement for URLLC and IIoT in NR-U in mobile communications, as described below.

In Release 15 (Rel-15) and Rel-16 of the 3GPP specification, the focus was on the enhancement of latency and reliability in a connected mode for URLLC, and idle/inactive mode was not considered for enhancement. In Rel-16, for PRACH transmissions, a UE (e.g., UE 110) needs to detect a DL transmission in a gNB-initiated COT before performing a PRACH transmission. It would be beneficial to transmit PRACH with a UE-initiated COT for latency enhancement. For instance, this would be beneficial for URLLC battery-powered devices such as sensors which tend to be frequently in an idle mode for power conservation. In view of this, under a proposed scheme in accordance with the present disclosure, a UE may be configured, either semi-statically or dynamically by a network, to initiate a COT for PRACH transmissions while in an idle or connected mode. For instance, UEs with high-priority traffic or mixed high- and low-priority traffic may have this functionality enabled by the gNB (e.g., enabled for high-priority traffic, disabled for low-priority traffic).

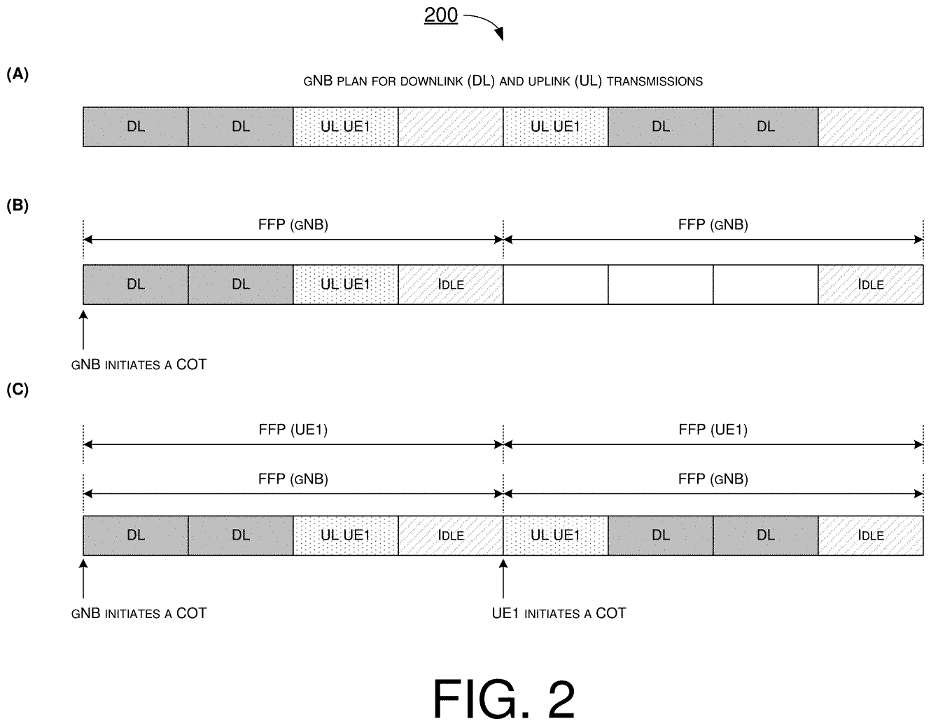

FIG. 2 illustrates an example scenario 200 under various proposed schemes in accordance with the present disclosure. Part (A) of FIG. 2 shows a gNB's plan for DL and UL transmissions in a semi-static channel access mode such as the FBE mode, in which only gNB-initiated COT is supported. As shown in part (A) of FIG. 2, the gNB may plan for some DL transmissions by the gNB and some UL transmissions by a first UE or UE1 (e.g., UE 110). Part (B) of FIG. 2 shows a case in which there are possible DL and UL transmissions with only the gNB as a COT initiator. Specifically, in a first FFP, there may be some DL transmissions by the gNB, an UL transmission by UE1, and an idle period. Moreover, in a second FFP, there may be unused periods and an idle period. Part (C) of FIG. 2 shows a case in which there are possible DL and UL transmissions with each of the gNB and UE1 as a COT initiator under various proposed schemes in accordance with the present disclosure. Specifically, in a first FFP of a gNB-initiated COT, there may be some DL transmissions by the gNB, an UL transmission by UE1, and an idle period. Moreover, in a second FFP of a UE-initiated COT, there may be an UL transmission by UE1, some DL transmissions by the gNB, and an idle period.

Under a proposed scheme in accordance with the present disclosure, there may be two options regarding PRACH overlapping with a gNB idle period. In a first option (option A), a PRACH resource may be allowed to overlap with the gNB idle period in case it is within a UE-initiated COT. For instance, even with COT sharing, the sharing rule (e.g., idle periods are not used by both gNB and UE) may be not applied for a PRACH transmission. In a second option (option B), a PRACH resource may not be allowed to overlap with the gNB idle period even if it is within a UE-initiated COT. For instance, the PRACH resource may not be allowed during COT sharing (when the sharing rule is applied).

Under a proposed scheme in accordance with the present disclosure, when a PRACH transmission occurs in a UE-initiated COT, the PRACH transmission may be appended or multiplexed with some or all of the following information: (a) the UE has initiated its own COT, and (b) whether the UE shares its initiated COT with the gNB (e.g., similar to configured grant uplink control information (CG-UCI) COT sharing information).

Under a proposed scheme in accordance with the present disclosure, a UE-initiated COT carrying PRACH may be automatically shared with the gNB without any additional indication.

Regarding UE-to-gNB COT sharing in semi-static channel access, the gNB may share a UE-initiated COT following the detection of an UL transmission from the UE starting at the beginning of the FFP. In an example scenario: (a) the gNB may perform LBT and the LBT passes (e.g., channel clear); (b) the gNB then transmits DL data including UL grant for a first UE (UE1); (c) UE1 starts transmitting in UL; (d) a second UE (UE2) receives protocol data unit (PDU) data and intends to transmit to the gNB; (e) UE2 starts LBT to initiate a COT but fails; (f) UE2 performs another LBT after the end of the UL transmission by UE1 and the LBT passes; and (g) UE2 then starts UL transmission on a CG. In this example scenario, there is ambiguity in that the gNB cannot determine whether UE2 is sharing the gNB FFP (assuming gap<16 μs) or UE2 has initiated its own COT. There is also ambiguity in that the gNB needs to know in case it is to share the UE-initiated COT. There is another ambiguity in that UE2 does not know whether UE1 was scheduled in the gNB FFP as a responding device or UE1 has initiated its own COT.

In view of the above, under a proposed scheme in accordance with the present disclosure regarding UE-to-gNB COT sharing in semi-static channel access, a UE (e.g., UE 110) may include information in a CG (or DG) transmission to inform the gNB (e.g., network node 125) that the UE has initiated its own COT using either or both of a first option and a second option. In the first option (option 1), a new bit-field in the CG-UCI may be utilized to provide this indication. In the second option (option 2), an existing bit-field may be utilized for this indication. For instance, the CG-UCI COT sharing information may be re-used to determine this information. That is, in an event that this bit-field is enabled (e.g., value set to “1”), it may be interpreted as the UE did not start its own COT; otherwise, in an event that this bit-field is disabled (e.g., value set to “0”), it may be interpreted as the UE started its own COT.

Under a proposed scheme in accordance with the present disclosure regarding UE-to-gNB COT sharing in semi-static channel access, a UE (e.g., UE 110) may include information in a CG (or DG) transmission to inform the gNB (e.g., network node 125) that the UE is sharing its own initiated COT with the gNB. For instance, a bit-field in the CG-UCI may be added for this indication.

Under a proposed scheme in accordance with the present disclosure regarding UE-to-gNB COT sharing in semi-static channel access, whether or not a UE (e.g., UE 110) has started its own COT during a gNB-initiated COT may be interpreted using a CG-UCI COT sharing information bit-field. For instance, in an event that the UE has an UL CG transmission and in case the CG-UCI COT sharing information bit-field is enabled (e.g., value set to “1”), it may be interpreted as the UE did not start its own COT. Otherwise, in an event that the UE has an UL CG transmission and in case the CG-UCI COT sharing information bit-field is disabled (e.g., value set to “0”), it may be interpreted as the UE started its own COT.

Under a proposed scheme in accordance with the present disclosure regarding FFP parameters for UE-initiated COT, FFP parameters for UE-initiated COT functionality may be provided to a UE (e.g., UE 110) via RRC signaling or by dynamically configuring the UE. For instance, the COT-initiating capability or functionality of the UE may be enabled and disabled via RRC signaling or dynamically configured by a gNB (e.g., network node 125). For instance, UE COT-initiating functionality may be disabled for UEs with low-priority traffic and, in such a case, those UEs may rely on gNB-initiated COT. Moreover, UE COT-initiating functionality may be enabled for UEs with high-priority traffic or mixed high- and low-priority traffic.

Under a proposed scheme in accordance with the present disclosure regarding FFP parameters for UE-initiated COT, the FFP periodicity at the UE may be determined by the UE implicitly from other higher-layer parameters. That is, there may be no explicit signaling of the FFP periodicity as other higher-layer parameters may be used. For instance, the periodicity of CG resources may be utilized by a UE to implicitly determine the FFP periodicity. Advantageously, this may reduce RRC signaling overhead. The use of higher-layer parameters may be overridden by explicit signaling.

Under a proposed scheme in accordance with the present disclosure regarding FFP parameters for UE-initiated COT, in case that CG configuration is used to determine FFP parameters (e.g., periodicity) and in case of multiple CG configurations, a specific CG configuration may be used by a UE (e.g., UE 110) to determine the FFP periodicity. For instance, the CG configuration with the lowest index or the CG configuration with the smallest (or largest) periodicity (e.g., 1 ms) may be used by the UE to determine the FFP periodicity. Under the proposed scheme, in case that CG configuration is used to determine FFP parameters (e.g., periodicity), the CG periodicity may need to be in the list of times {1 ms, 2 ms, 2.5 ms, 4 ms, 5 ms, 10 ms} or otherwise it may not be selected.

Under a proposed scheme in accordance with the present disclosure, a UE (e.g., UE 110) may be explicitly indicated by a gNB (e.g., network node 125) with DCI on whether or not to initiate a COT in a next FFP associated with the UE. Indication by DCI may provide more control to the gNB in enabling and disabling UEs transmitting low-priority traffic (e.g., enhanced Mobile Broadband (eMBB) traffic). Under the proposed scheme, initiation of a COT by a UE may be limited to high-priority traffic (e.g., high-priority configured grant (HP-CG), high-priority scheduling request (HP-SR), high-priority hybrid automatic repeat request acknowledgement (HP-HARQ-ACK), and so on) as UEs with low-priority traffic may rely on gNB-initiated COTs. For instance, a physical layer (PHY) priority (e.g., indicated by a bit-field) of a channel may be used to determine whether UE COT initiation is enabled or not for that channel. Additionally, or alternatively, a medium access control (MAC) layer priority (e.g., logical channel (LCH) priorities) of a channel may be used to determine whether UE COT initiation is enabled or not for that channel. Accordingly, UE COT initiation may be enabled or disabled per configuration (e.g., CG configuration, SR configuration, PUCCH-config configuration).

Under a proposed scheme in accordance with the present disclosure, in case that DCI is used by a gNB (e.g., network node 125) to indicate to a UE (e.g., UE 110) whether or not to initiate a COT, the DCI may also be utilized to enable one or more other aspects of COT initiation by the UE. For instance, the DCI may enable UE COT initiation for a next UE FFP only. Alternatively, or additionally, the DCI may enable UE COT initiation for all coming UE FFPs till another DCI disables it. Alternatively, or additionally, the DCI may enable UE COT initiation for some specific FFPs (e.g., with FFP index signaled and FFP pattern used). For instance, index pointing to a specific future FFP may be signaled to the UE (e.g., similar to K1 pointing to PUCCH feedback slot and/or sub-slot). Under the proposed scheme, in an event that DCI is used to indicate to the UE whether or not to initiate a COT, the UE may acknowledge the reception of this information. For instance, a HARQ-ACK mechanism may be utilized to send the acknowledgement. Alternatively, or additionally, a MAC control element (CE) (e.g., MAC CE) may be utilized to send the acknowledgement.

### Illustrative Implementations

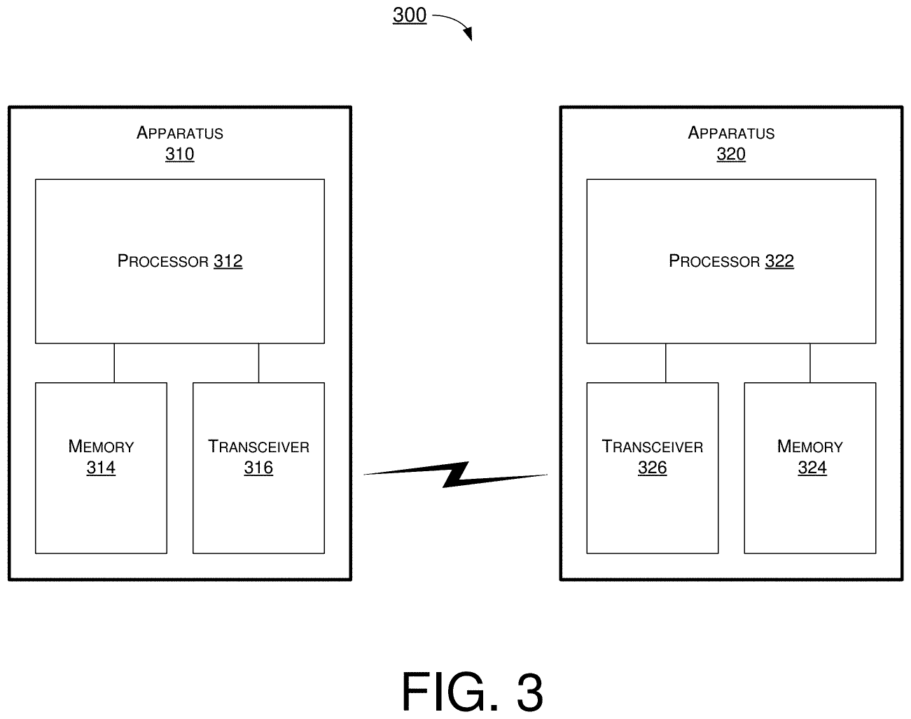

FIG. 3 illustrates an example communication system 300 having an example communication apparatus 310 and an example network apparatus 320 in accordance with an implementation of the present disclosure. Each of communication apparatus 310 and network apparatus 320 may perform various functions to implement schemes, techniques, processes and methods described herein pertaining to FBE UE-initiated COT enhancement for URLLC and IIoT in NR-U in mobile communications, including scenarios/schemes described above as well as processes described below.

Communication apparatus 310 may be a part of an electronic apparatus, which may be a UE such as a portable or mobile apparatus, a wearable apparatus, a wireless communication apparatus or a computing apparatus. For instance, communication apparatus 310 may be implemented in a smartphone, a smartwatch, a personal digital assistant, a digital camera, or a computing equipment such as a tablet computer, a laptop computer or a notebook computer. Communication apparatus 310 may also be a part of a machine type apparatus, which may be an IoT, NB-IoT, IIoT or NTN apparatus such as an immobile or a stationary apparatus, a home apparatus, a wire communication apparatus or a computing apparatus. For instance, communication apparatus 310 may be implemented in a smart thermostat, a smart fridge, a smart door lock, a wireless speaker or a home control center. Alternatively, communication apparatus 310 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. Communication apparatus 310 may include at least some of those components shown in FIG. 3 such as a processor 312, for example. Communication apparatus 310 may further include one or more other components not pertinent to the proposed scheme of the present disclosure (e.g., internal power supply, display device and/or user interface device), and, thus, such component(s) of communication apparatus 310 are neither shown in FIG. 3 nor described below in the interest of simplicity and brevity.

Network apparatus 320 may be a part of an electronic apparatus/station, which may be a network node such as a base station, a small cell, a router, a gateway or a satellite. For instance, network apparatus 320 may be implemented in an eNodeB in an LTE, in a gNB in a 5G, NR, IoT, NB-IoT, IIoT, or in a satellite in an NTN network. Alternatively, network apparatus 320 may be implemented in the form of one or more IC chips such as, for example and without limitation, one or more single-core processors, one or more multi-core processors, or one or more RISC or CISC processors. Network apparatus 320 may include at least some of those components shown in FIG. 3 such as a processor 322, for example. Network apparatus 320 may further include one or more other components not pertinent to the proposed scheme of the present disclosure (e.g., internal power supply, display device and/or user interface device), and, thus, such component(s) of network apparatus 320 are neither shown in FIG. 3 nor described below in the interest of simplicity and brevity.

In one aspect, each of processor 312 and processor 322 may be implemented in the form of one or more single-core processors, one or more multi-core processors, one or more RISC processors, or one or more CISC processors. That is, even though a singular term “a processor” is used herein to refer to processor 312 and processor 322, each of processor 312 and processor 322 may include multiple processors in some implementations and a single processor in other implementations in accordance with the present disclosure. In another aspect, each of processor 312 and processor 322 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 312 and processor 322 is a special-purpose machine specifically designed, arranged and configured to perform specific tasks including FBE UE-initiated COT enhancement for URLLC and IIoT in NR-U in mobile communications in accordance with various implementations of the present disclosure.

In some implementations, communication apparatus 310 may also include a transceiver 316 coupled to processor 312 and capable of wirelessly transmitting and receiving data. In some implementations, communication apparatus 310 may further include a memory 314 coupled to processor 312 and capable of being accessed by processor 312 and storing data therein. In some implementations, network apparatus 320 may also include a transceiver 326 coupled to processor 322 and capable of wirelessly transmitting and receiving data. In some implementations, network apparatus 320 may further include a memory 324 coupled to processor 322 and capable of being accessed by processor 322 and storing data therein. Accordingly, communication apparatus 310 and network apparatus 320 may wirelessly communicate with each other via transceiver 316 and transceiver 326, respectively.

Each of communication apparatus 310 and network apparatus 320 may be a communication entity capable of communicating with each other using various proposed schemes in accordance with the present disclosure. To aid better understanding, the following description of the operations, functionalities and capabilities of each of communication apparatus 310 and network apparatus 320 is provided in the context of a mobile communication environment in which communication apparatus 310 is implemented in or as a communication apparatus or a UE (e.g., UE 110) and network apparatus 320 is implemented in or as a network node or base station (e.g., network node 125) of a communication network (e.g., wireless network 120). It is also noteworthy that, although the example implementations described below are provided in the context of mobile communications, the same may be implemented in other types of networks.

Under various proposed schemes pertaining to FBE UE-initiated COT enhancement for URLLC and IIoT in NR-U in mobile communications in accordance with the present disclosure, with communication apparatus 310 implemented in or as UE 110 and network apparatus 320 implemented in or as network node 125 in network environment 100, processor 312 of communication apparatus 310 may receive, via transceiver 316, a signal from a network (e.g., network 120 via apparatus 320 as network node 125). Additionally, processor 312 may obtain, via transceiver 316, a UE-initiated COT in an idle or connected mode responsive to receiving the signal. Moreover, processor 312 may perform, via transceiver 316, a transmission to the network (e.g., network 120 via apparatus 320 as network node 125) in the UE-initiated COT.

In some implementations, in receiving the signal, processor 312 may receive, semi-statically via RRC or dynamically via DCI, the signal that configures the UE to perform COT initiation.

In some implementations, in receiving the signal, processor 312 may receive an RRC signal used by the network to enable or disable a COT-initiation functionality of the UE. In some implementations, the RRC signal may enable the COT-initiation functionality in an event that the UE has a high-priority traffic (e.g., URLLC, HP-CG, HP-SR, HP-HARQ-ACK) or a mixture of the high-priority traffic and a low-priority traffic (e.g., eMBB) for transmission. Moreover, the RRC signal may disable the COT-initiation functionality in an event that the UE has the low-priority traffic but not the high-priority traffic for transmission. In some implementations, the RRC signal may also configure one or more FFP parameters (e.g., periodicity).

In some implementations, in receiving the signal, processor 312 may receive a CG configuration based on which the UE determines one or more FFP parameters.

In some implementations, in receiving the signal, processor 312 may receive a DCI with an indication informing the UE whether or not to initiate a COT in a FFP associated with the UE. In some implementations, the DCI may enable the UE to perform COT initiation for a next FFP associated with the UE and not any other FFP. Alternatively, the DCI may enable the UE to perform COT initiation for all future FFPs associated with the UE until a COT-initiation functionality of the UE is disabled. Still alternatively, the DCI may enable the UE to perform COT initiation for one or more specific FFPs associated with the UE.

In some implementations, in receiving the signal, processor 312 may receive the signal that enables or disables a COT-initiation functionality of the UE per CG configuration, per SR configuration, or per PUCCH-config configuration.

In some implementations, in receiving the signal, processor 312 may receive the signal enables the UE to perform COT initiation in an event that the UE has an URLLC traffic to transmit. In such cases, in performing the transmission, processor 312 may transmit the URLLC traffic.

In some implementations, in performing the transmission, processor 312 may perform a PRACH transmission. In some implementations, the UE-initiated COT carrying the PRACH transmission may be automatically shared with the network without any indication from the UE to the network. In some implementations, a PRACH resource used in performing the PRACH transmission may be allowed to overlap with an idle period of the network in an event that the PRACH resource is within the UE-initiated COT. Alternatively, a PRACH resource used in performing the PRACH transmission may not be allowed to overlap with an idle period of the network even when the PRACH resource is within the UE-initiated COT.

In some implementations, in performing the transmission, processor 312 may perform a CG or DG transmission to the network in the UE-initiated COT with an indication informing the network that the UE-initiated COT is shared with the network. In some implementations, the indication may include a bit-field in a CG-UCI.

In some implementations, processor 312 may perform additional operations. For instance, processor 312 may transmit, via transceiver 316, an acknowledgement to the network acknowledging receipt of the signal. In such cases, the signal received from the network may include a DCI indicating to the UE whether or not to perform COT initiation. In some implementations, the acknowledgement may include a HARQ-ACK or a MAC CE.

Under various proposed schemes pertaining to FBE UE-initiated COT enhancement for URLLC and IIoT in NR-U in mobile communications in accordance with the present disclosure, with communication apparatus 310 implemented in or as UE 110 and network apparatus 320 implemented in or as network node 125 in network environment 100, processor 312 of communication apparatus 310 may receive, via transceiver 316, a signal from a network (e.g., network 120 via apparatus 320 as network node 125). For instance, process 500 may involve processor 312 receiving an RRC signal or a dynamic signal (e.g., DCI) used by the network to enable or disable a COT-initiation functionality of the UE. Additionally, processor 312 may obtain, via transceiver 316, a UE-initiated COT responsive to receiving the signal. Moreover, processor 312 may perform, via transceiver 316, a transmission to the network (e.g., network 120 via apparatus 320 as network node 125) in the UE-initiated COT.

In some implementations, the RRC signal may enable the COT-initiation functionality in an event that the UE has a high-priority traffic or a mixture of the high-priority traffic and a low-priority traffic for transmission. Moreover, the RRC signal may disable the COT-initiation functionality in an event that the UE has the low-priority traffic but not the high-priority traffic for transmission.

In some implementations, the RRC signal may also configure one or more FFP parameters.

Under various proposed schemes pertaining to FBE UE-initiated COT enhancement for URLLC and IIoT in NR-U in mobile communications in accordance with the present disclosure, with communication apparatus 310 implemented in or as UE 110 and network apparatus 320 implemented in or as network node 125 in network environment 100, processor 312 of communication apparatus 310 may receive, via transceiver 316, from a network node of a network (e.g., from network 120 via apparatus 320 as network node 125) a DCI with an indication informing the UE whether or not to initiate a COT in a FFP associated with the UE or the network node in a future FFP. Additionally, processor 312 may obtain, via transceiver 316, a UE-initiated COT in an idle or connected mode responsive to receiving the signal. Moreover, processor 312 may perform, via transceiver 316, a transmission to the network (e.g., network 120 via apparatus 320 as network node 125) in the UE-initiated COT.

In some implementations, the DCI may enable the UE to perform COT initiation for a next FFP associated with the UE and not any other FFP. Alternatively, or additionally, the DCI may enable the UE to perform COT initiation for all future FFPs associated with the UE until a COT-initiation functionality of the UE is disabled. Alternatively, or additionally, the DCI may enable the UE to perform COT initiation for one or more specific FFPs associated with the UE.

### Illustrative Processes

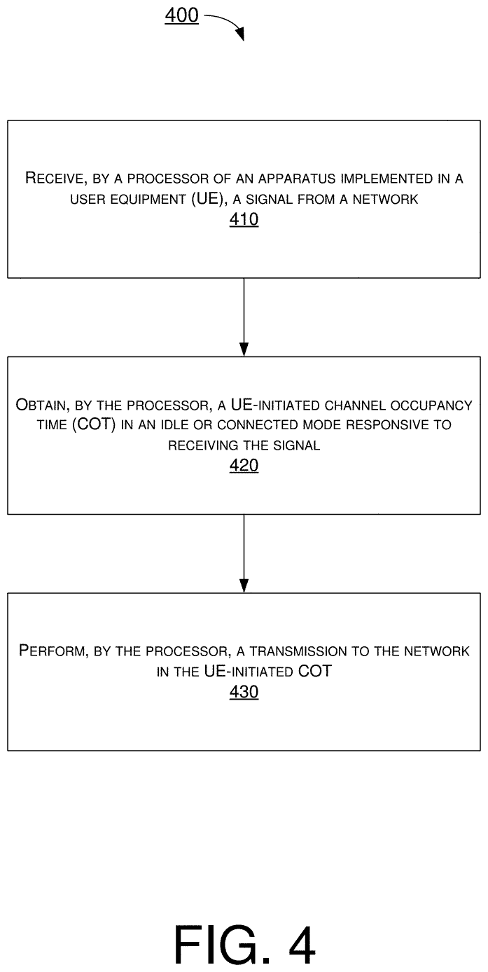

FIG. 4 illustrates an example process 400 in accordance with an implementation of the present disclosure. Process 400 may be an example implementation of schemes described above whether partially or completely, with respect to FBE UE-initiated COT enhancement for URLLC and IIoT in NR-U in mobile communications in accordance with the present disclosure. Process 400 may represent an aspect of implementation of features of communication apparatus 310 and network apparatus 320. Process 400 may include one or more operations, actions, or functions as illustrated by one or more of blocks 410, 420 and 430. Although illustrated as discrete blocks, various blocks of process 400 may be divided into additional blocks, combined into fewer blocks, or eliminated, depending on the desired implementation. Moreover, the blocks of process 400 may executed in the order shown in FIG. 4 or, alternatively, in a different order. Process 400 may be implemented by communication apparatus 310 or any suitable UE or machine type devices as well as by and network apparatus 320 or any suitable network node or base station. Solely for illustrative purposes and without limitation, process 400 is described below in the context of communication apparatus 310 implemented in or as UE 110 and network apparatus 320 implemented in or as network node 125. Process 400 may begin at block 410.

At 410, process 400 may involve processor 312 of communication apparatus 310, implemented in or as UE 110, receiving, via transceiver 316, a signal from a network (e.g., network 120 via apparatus 320 as network node 125). Process 400 may proceed from 410 to 420.

At 420, process 400 may involve processor 312 obtaining, via transceiver 316, a UE-initiated COT in an idle or connected mode responsive to receiving the signal. Process 400 may proceed from 420 to 430.

At 430, process 400 may involve processor 312 performing, via transceiver 316, a transmission to the network (e.g., network 120 via apparatus 320 as network node 125) in the UE-initiated COT.

In some implementations, in receiving the signal, process 400 may involve processor 312 receiving, semi-statically via RRC or dynamically via DCI, the signal that configures the UE to perform COT initiation.

In some implementations, in receiving the signal, process 400 may involve processor 312 receiving an RRC signal used by the network to enable or disable a COT-initiation functionality of the UE. In some implementations, the RRC signal may enable the COT-initiation functionality in an event that the UE has a high-priority traffic (e.g., URLLC, HP-CG, HP-SR, HP-HARQ-ACK) or a mixture of the high-priority traffic and a low-priority traffic (e.g., eMBB) for transmission. Moreover, the RRC signal may disable the COT-initiation functionality in an event that the UE has the low-priority traffic but not the high-priority traffic for transmission. In some implementations, the RRC signal may also configure one or more FFP parameters (e.g., periodicity).

In some implementations, in receiving the signal, process 400 may involve processor 312 receiving a CG configuration based on which the UE determines one or more FFP parameters.

In some implementations, in receiving the signal, process 400 may involve processor 312 receiving a DCI with an indication informing the UE whether or not to initiate a COT in a FFP associated with the UE. In some implementations, the DCI may enable the UE to perform COT initiation for a next FFP associated with the UE and not any other FFP. Alternatively, the DCI may enable the UE to perform COT initiation for all future FFPs associated with the UE until a COT-initiation functionality of the UE is disabled. Still alternatively, the DCI may enable the UE to perform COT initiation for one or more specific FFPs associated with the UE.

In some implementations, in receiving the signal, process 400 may involve processor 312 receiving the signal that enables or disables a COT-initiation functionality of the UE per CG configuration, per SR configuration, or per PUCCH-config configuration.

In some implementations, in receiving the signal, process 400 may involve processor 312 receiving the signal enables the UE to perform COT initiation in an event that the UE has an URLLC traffic to transmit. In such cases, in performing the transmission, process 400 may involve processor 312 transmitting the URLLC traffic.

In some implementations, in performing the transmission, process 400 may involve processor 312 performing a PRACH transmission. In some implementations, the UE-initiated COT carrying the PRACH transmission may be automatically shared with the network without any indication from the UE to the network. In some implementations, a PRACH resource used in performing the PRACH transmission may be allowed to overlap with an idle period of the network in an event that the PRACH resource is within the UE-initiated COT. Alternatively, a PRACH resource used in performing the PRACH transmission may not be allowed to overlap with an idle period of the network even when the PRACH resource is within the UE-initiated COT.

In some implementations, in performing the transmission, process 400 may involve processor 312 performing a CG or DG transmission to the network in the UE-initiated COT with an indication informing the network that the UE-initiated COT is shared with the network. In some implementations, the indication may include a bit-field in a CG-UCI.

In some implementations, process 400 may involve processor 312 performing additional operations. For instance, process 400 may involve processor 312 transmitting, via transceiver 316, an acknowledgement to the network acknowledging receipt of the signal. In such cases, the signal received from the network may include a DCI indicating to the UE whether or not to perform COT initiation. In some implementations, the acknowledgement may include a HARQ-ACK or a MAC CE.

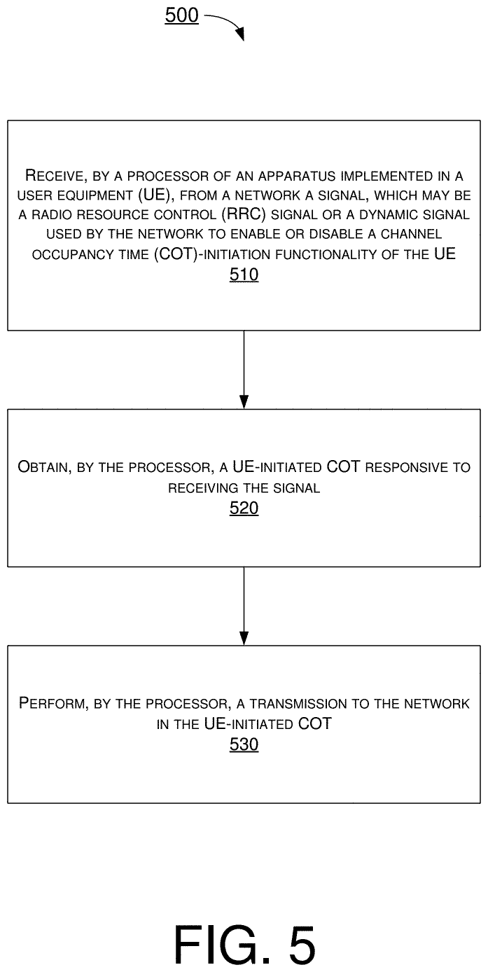

FIG. 5 illustrates an example process 500 in accordance with an implementation of the present disclosure. Process 500 may be an example implementation of schemes described above whether partially or completely, with respect to FBE UE-initiated COT enhancement for URLLC and IIoT in NR-U in mobile communications in accordance with the present disclosure. Process 500 may represent an aspect of implementation of features of communication apparatus 310 and network apparatus 320. Process 500 may include one or more operations, actions, or functions as illustrated by one or more of blocks 510, 520 and 530. Although illustrated as discrete blocks, various blocks of process 500 may be divided into additional blocks, combined into fewer blocks, or eliminated, depending on the desired implementation. Moreover, the blocks of process 500 may executed in the order shown in FIG. 5 or, alternatively, in a different order. Process 500 may be implemented by communication apparatus 310 or any suitable UE or machine type devices as well as by and network apparatus 320 or any suitable network node or base station. Solely for illustrative purposes and without limitation, process 500 is described below in the context of communication apparatus 310 implemented in or as UE 110 and network apparatus 320 implemented in or as network node 125. Process 500 may begin at block 510.

At 510, process 500 may involve processor 312 of communication apparatus 310, implemented in or as UE 110, receiving, via transceiver 316, a signal from a network (e.g., network 120 via apparatus 320 as network node 125). For instance, process 500 may involve processor 312 receiving an RRC signal or a dynamic signal (e.g., DCI) used by the network to enable or disable a COT-initiation functionality of the UE. Process 500 may proceed from 510 to 520.

At 520, process 500 may involve processor 312 obtaining, via transceiver 316, a UE-initiated COT responsive to receiving the signal. Process 500 may proceed from 520 to 530.

At 530, process 500 may involve processor 312 performing, via transceiver 316, a transmission to the network (e.g., network 120 via apparatus 320 as network node 125) in the UE-initiated COT.

In some implementations, the RRC signal may enable the COT-initiation functionality in an event that the UE has a high-priority traffic or a mixture of the high-priority traffic and a low-priority traffic for transmission. Moreover, the RRC signal may disable the COT-initiation functionality in an event that the UE has the low-priority traffic but not the high-priority traffic for transmission.

In some implementations, the RRC signal may also configure one or more FFP parameters.

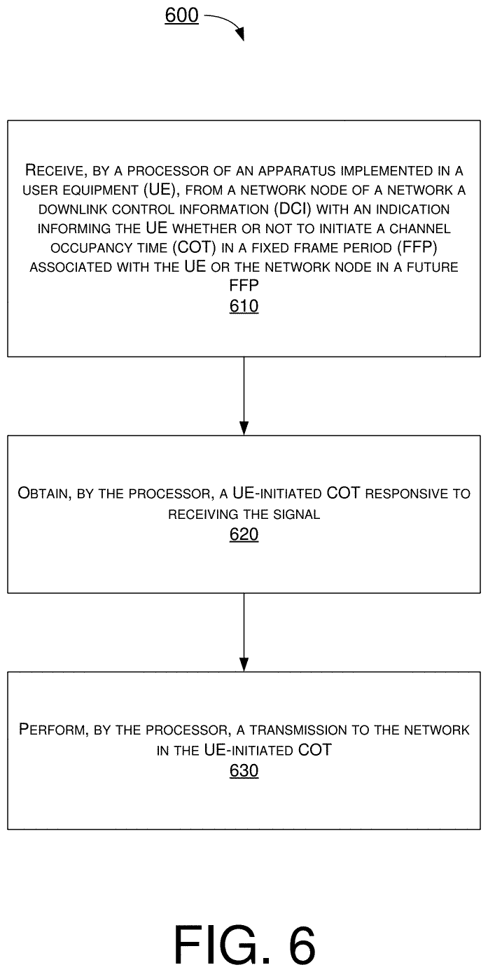

FIG. 6 illustrates an example process 600 in accordance with an implementation of the present disclosure. Process 600 may be an example implementation of schemes described above whether partially or completely, with respect to FBE UE-initiated COT enhancement for URLLC and IIoT in NR-U in mobile communications in accordance with the present disclosure. Process 600 may represent an aspect of implementation of features of communication apparatus 310 and network apparatus 320. Process 600 may include one or more operations, actions, or functions as illustrated by one or more of blocks 610, 620 and 630. Although illustrated as discrete blocks, various blocks of process 600 may be divided into additional blocks, combined into fewer blocks, or eliminated, depending on the desired implementation. Moreover, the blocks of process 600 may executed in the order shown in FIG. 6 or, alternatively, in a different order. Process 600 may be implemented by communication apparatus 310 or any suitable UE or machine type devices as well as by and network apparatus 320 or any suitable network node or base station. Solely for illustrative purposes and without limitation, process 600 is described below in the context of communication apparatus 310 implemented in or as UE 110 and network apparatus 320 implemented in or as network node 125. Process 600 may begin at block 610.

At 610, process 600 may involve processor 312 of communication apparatus 310, implemented in or as UE 110, receiving, via transceiver 316, from a network node of a network (e.g., from network 120 via apparatus 320 as network node 125) a DCI with an indication informing the UE whether or not to initiate a COT in a FFP associated with the UE or the network node in a future FFP. Process 600 may proceed from 610 to 620.

At 620, process 600 may involve processor 312 obtaining, via transceiver 316, a UE-initiated COT in an idle or connected mode responsive to receiving the signal. Process 600 may proceed from 620 to 630.

At 630, process 600 may involve processor 312 performing, via transceiver 316, a transmission to the network (e.g., network 120 via apparatus 320 as network node 125) in the UE-initiated COT.

In some implementations, the DCI may enable the UE to perform COT initiation for a next FFP associated with the UE and not any other FFP. Alternatively, or additionally, the DCI may enable the UE to perform COT initiation for all future FFPs associated with the UE until a COT-initiation functionality of the UE is disabled. Alternatively, or additionally, the DCI may enable the UE to perform COT initiation for one or more specific FFPs associated with the UE.

### Additional Notes

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
receiving, by a processor of an apparatus implemented in a user equipment (UE), a signal from a network;
obtaining, by the processor, a UE-initiated channel occupancy time (COT) in an idle or connected mode responsive to receiving the signal; and
performing, by the processor, a transmission to the network in the UE-initiated COT.

2. The method of claim 1, wherein the receiving of the signal comprises receiving, semi-statically via radio resource control (RRC) or dynamically via downlink control information (DCI), the signal that configures the UE to perform COT initiation.

3. The method of claim 1, wherein the receiving of the signal comprises receiving a configured grant (CG) configuration based on which the UE determines one or more fixed frame period (FFP) parameters.

4. The method of claim 1, wherein the receiving of the signal comprises receiving the signal that enables or disables a COT-initiation functionality of the UE per configured grant (CG) configuration, per scheduling request (SR) configuration, or per physical uplink control channel (PUCCH)-config configuration.

5. The method of claim 1, wherein the receiving of the signal comprises receiving the signal enables the UE to perform COT initiation in an event that the UE has an ultra-reliable low-latency communication (URLLC) traffic to transmit, and wherein the performing of the transmission comprises transmitting the URLLC traffic.

6. The method of claim 1, wherein the performing of the transmission comprises performing a physical random access channel (PRACH) transmission.

7. The method of claim 6, wherein the UE-initiated COT carrying the PRACH transmission is automatically shared with the network without any indication from the UE to the network.

8. The method of claim 6, wherein a PRACH resource used in performing the PRACH transmission is allowed to overlap with an idle period of the network in an event that the PRACH resource is within the UE-initiated COT.

9. The method of claim 6, wherein a PRACH resource used in performing the PRACH transmission is not allowed to overlap with an idle period of the network even when the PRACH resource is within the UE-initiated COT.

10. The method of claim 1, wherein the performing of the transmission comprises performing a configured grant (CG) or dynamic grant (DG) transmission to the network in the UE-initiated COT with an indication informing the network that the UE-initiated COT is shared with the network.

11. The method of claim 10, wherein the indication comprises a bit-field in a configured grant uplink control information (CG-UCI).

12. The method of claim 1, further comprising:
transmitting, by the processor, an acknowledgement to the network acknowledging receipt of the signal,
wherein the signal received from the network comprises a downlink control information (DCI) indicating to the UE whether or not to perform COT initiation.

13. The method of claim 12, wherein the acknowledgement comprises a hybrid automatic repeat request acknowledgement (HARQ-ACK) or a medium access control (MAC) control element (CE).

14. A method, comprising:
receiving, by a processor of an apparatus implemented in a user equipment (UE), a signal from a network;
obtaining, by the processor, a UE-initiated channel occupancy time (COT) responsive to receiving the signal; and
performing, by the processor, a transmission to the network in the UE-initiated COT,
wherein the receiving of the signal comprises receiving a radio resource control (RRC) signal or a dynamic signal used by the network to enable or disable a COT-initiation functionality of the UE.

15. The method of claim 14, wherein the RRC signal enables the COT-initiation functionality in an event that the UE has a high-priority traffic or a mixture of the high-priority traffic and a low-priority traffic for transmission.

16. The method of claim 14, wherein the RRC signal disables the COT-initiation functionality in an event that the UE has the low-priority traffic but not the high-priority traffic for transmission.

17. The method of claim 14, wherein the RRC signal further configures one or more fixed frame period (FFP) parameters.

18. The method of claim 17, wherein the DCI enables the UE to perform COT initiation for a next FFP associated with the UE and not any other FFP.

19. The method of claim 17, wherein the DCI enables the UE to perform COT initiation for all future FFPs associated with the UE until a COT-initiation functionality of the UE is disabled.

20. The method of claim 17, wherein the DCI enables the UE to perform COT initiation for one or more specific FFPs associated with the UE.
